(19) United States
(12) Patent Application Publication
(10) Pub. No.: US 2021/0380356 A1
(43) Pub. Date: Dec. 9, 2021

(54) SYSTEMS AND METHODS FOR PALLETIZATION MINIATURIZATION AND DEMONSTRATION

(71) Applicant: Associated Packaging, Inc., Gallatin, TN (US)

(72) Inventor: Kevin Lee Miller, Mt. Juliet, TN (US)

(21) Appl. No.: 16/892,737

(22) Filed: Jun. 4, 2020

(51) Int. Cl. B65G 61/00; B25J 9/16; B25J 9/00; B25J 11/00

(52) U.S. Cl. CPC B65G 61/00; B25J 9/1628; B25J 15/06; B25J 11/005; B25J 9/0093

(57) ABSTRACT

An apparatus for palletization miniaturization and demonstration may include a miniaturized palletization surface that may include a horizontal surface, a miniaturized conveyor disposed on the horizontal surface, a miniaturized material mass, a miniaturized pallet disposed on the horizontal surface, and a miniaturized articulated robot disposed on the horizontal surface, the miniaturized articulated robot including an arm section and an end effector. The miniaturized pallet may be disposed within a reach of the arm section of the miniaturized articulated robot. The miniaturized articulated robot may be operable to grasp, via the end effector, the miniaturized material mass and translate the miniaturized material mass in a horizontal plane, a vertical plane, and a depth plane.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present disclosure relates generally to palletization and more particularly to systems and methods for palletization miniaturization and demonstration.

Palletization with robotics, i.e., the loading of a pallet with various loads using a robot, is common in manufacturing. However, robotic palletization is very expensive. The robots themselves are a large expense, and moving them around a factory floor takes time and effort. Initially setting up the robot, conveyors, pallets, or other components in an efficient configuration can save time and money. However, planning out a palletization configuration with the positions of the various components can be difficult. Even if a configuration is planned, it is difficult to determine if the configuration will work as planned without actually implementing the configuration. What is needed, then, are improvements to palletization systems.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the disclosure is an apparatus. The apparatus may include a miniaturized palletization surface. The miniaturized palletization surface may include a horizontal surface and a miniaturized conveyor disposed on the horizontal surface. The miniaturized conveyor may include a conveying surface. The apparatus may include a miniaturized material mass. The apparatus may include a miniaturized pallet disposed on the horizontal surface. The apparatus may include a miniaturized articulated robot disposed on the horizontal surface. The miniaturized articulated robot may include an arm section and an end effector disposed on an end of the arm section. The miniaturized pallet may be disposed within a reach of the arm section of the miniaturized articulated robot. The miniaturized articulated robot may be operable to grasp, via the end effector, the miniaturized material mass and translate the miniaturized material mass in a horizontal plane, a vertical plane, and a depth plane.

Another aspect of the disclosure includes a system. The system may include a miniaturized palletization demonstration apparatus. The apparatus may include a miniaturized palletization surface. The miniaturized palletization surface may include a horizontal surface and a miniaturized conveyor disposed on the horizontal surface. The miniaturized conveyor may include a conveying surface. The apparatus may include a miniaturized material mass. The apparatus may include a miniaturized pallet disposed on the horizontal surface. The apparatus may include a miniaturized articulated robot disposed on the horizontal surface. The miniaturized articulated robot may include an arm section and an end effector disposed on an end of the arm section. The system may include a computing device. The computing device may include at least one processor and a computer-readable storage medium with a plurality of computer-readable instructions stored thereon. When the plurality of computer-readable instructions are executed by the processor, the processor may be operable to send a plurality of signals to the miniaturized articulated robot. The miniaturized articulated robot, in response to receiving the plurality of signals, may be operable to grasp, via the end effector, the miniaturized material mass, and translate the miniaturized material mass in a horizontal plane, a vertical plane, and a depth plane.

Another aspect of the disclosure includes a method. The method may include obtaining sizing properties of a material mass related to a palletization process. The method may include obtaining palletization system physical properties related to the palletization process. The method may include generating a first miniaturized material mass based on the sizing properties. The method may include generating a pallet-stacking solution based on the sizing properties and the palletization system physical properties. The method may include disposing, based on the palletization system physical properties, a miniaturized conveyor, a miniaturized pallet, and a miniaturized articulated robot on a miniaturized palletization surface. The method may include disposing the first miniaturized material mass on the miniaturized conveyor. The method may include sending, via a computing device, a first plurality of signals to the miniaturized articulated robot. The first plurality of signals may be based on the pallet-stacking solution. The method may include, in response to receiving the first plurality of signals at the miniaturized articulated robot, grasping, via an end effector of the miniaturized articulated robot, the first miniaturized material mass and disposing, via the miniaturized articulated robot, the first miniaturized material mass on the miniaturized pallet or on a second miniaturized material mass.

In some embodiments, the apparatuses, systems, and methods disclosed herein may provide a demonstration of a specific configuration of robotic palletization. A demonstration may show proof of concept that the specific configuration of robot palletization is possible, efficient, or otherwise desirable before attempting to implement the full-scale robotic palletization solution. Providing the robotic palletization scale model may reduce overhead burden or expense or may provide a solution before a full-scale location is available. The scale model may be transported or filmed in order to demonstrate the configuration to a variety of potential customers. A demonstration may assist with training or educational purposes. The demonstration of the palletization process with a miniaturized palletization system may be more economical or practical before attempting to implement the full-scale robotic palletization solution. Numerous other objects, advantages and features of the present disclosure will be readily apparent to those of skill in the art upon a review of the following drawings and description of a preferred embodiment.

### BRIEF DESCRIPTION OF THE DRAWINGS

FIG. 1 is a perspective view illustrating one embodiment of an apparatus for palletization miniaturization and demonstration.

FIG. 2A is a top down view illustrating one embodiment of the apparatus for palletization miniaturization and demonstration.

FIG. 2B is a top down view illustrating another embodiment of the apparatus for palletization miniaturization and demonstration where the end effector grasps the miniaturized material mass.

FIG. 2C is a top down view illustrating another embodiment of the apparatus for palletization miniaturization and demonstration where the miniaturized articulated robot translates the miniaturized material mass.

FIG. 2D is a top down view illustrating another embodiment of the apparatus for palletization miniaturization and demonstration where the miniaturized articulated robot disposes the miniaturized material mass over the miniaturized pallet.

FIG. 2E is a top down view illustrating another embodiment of the apparatus for palletization miniaturization and demonstration.

FIG. 3A is a top down view illustrating one embodiment of the apparatus for palletization miniaturization and demonstration.

FIG. 3B is a top down view illustrating another embodiment of the apparatus for palletization miniaturization and demonstration where the end effector of the miniaturized articulated robot grasps the miniaturized material mass.

FIG. 3C is a top down view illustrating another embodiment of the apparatus for palletization miniaturization and demonstration where the miniaturized articulated robot translates the miniaturized material mass.

FIG. 3D is a top down view illustrating another embodiment of the apparatus for palletization miniaturization and demonstration where the miniaturized articulated robot disposes the miniaturized material mass over the miniaturized conveyor.

FIG. 4A is a top down view illustrating a one-in two-out configuration of the apparatus for palletization miniaturization and demonstration.

FIG. 4B is a top down view illustrating another one-in two-out configuration of the apparatus for palletization miniaturization and demonstration.

FIG. 5 is a top down view illustrating a two-in two-out configuration of the apparatus for palletization miniaturization and demonstration.

FIG. 6A is a flowchart diagram illustrating a portion of a method for palletization miniaturization and demonstration.

FIG. 6B is a flowchart diagram illustrating another portion of the method for palletization miniaturization and demonstration.

FIG. 7 is a schematic block diagram illustrating one embodiment of a system for palletization miniaturization and demonstration.

### DETAILED DESCRIPTION

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use.

As used herein, the terms “miniature,” “miniaturized,” or other similar terms mean that the element the term describes is generally smaller than a conventional corresponding element. The terms do not necessarily mean that the element the term describes was once a full-sized element and was reconfigured to have a smaller size. For example, the miniaturized material mass element described below includes a material mass that is smaller than a corresponding, full-sized material mass.

As used herein, the a first component “corresponding” to a miniaturized component means that that miniaturized component is meant to simulate the first component at a smaller scale. For example, the miniaturized material mass corresponding to a material mass may include the miniaturized material mass being a smaller-scale version of the material mass. The miniaturized material mass may include the same portions as the material mass, but may have reduced dimensions. The miniaturized articulated robot corresponding to an articulated robot may include the miniaturized articulated robot including some of the same functionality as the articulated robot, but the miniaturized articulated robot may be smaller in size.

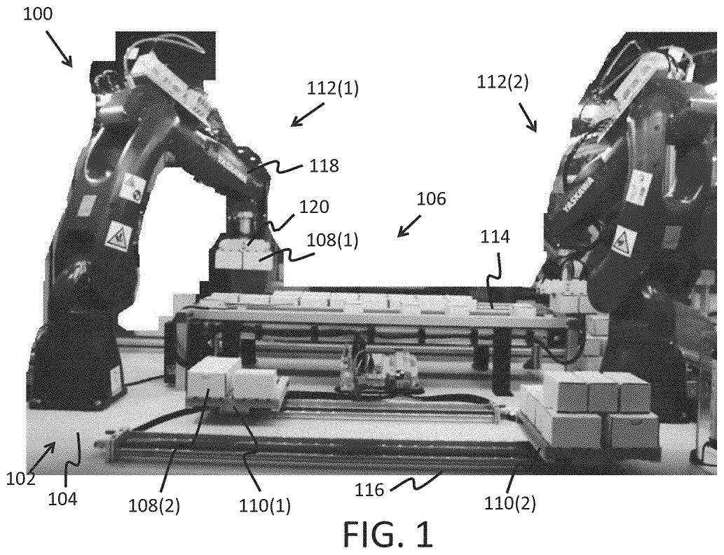

FIG. 1 depicts one embodiment of an apparatus 100. The apparatus 100 may include an apparatus for palletization miniaturization and demonstration. The apparatus 100 may include a miniaturized palletization surface 102. The miniaturized palletization surface 102 may include a horizontal surface 104. The miniaturized palletization surface 102 may include a miniaturized conveyor 106. The miniaturized conveyor 106 may be disposed on the horizontal surface 104.

The apparatus 100 may include a miniaturized material mass 108. The apparatus 100 may include a miniaturized pallet 110. The miniaturized pallet 110 may be disposed on the horizontal surface 104. The apparatus 100 may include a miniaturized articulated robot 112. The miniaturized articulated robot 112 may be disposed on the horizontal surface 104.

The apparatus 100 may provide a scale model of robotic palletization. This may be effective to show proof of concept that a specific configuration of robot palletization is possible, efficient, or otherwise desirable before attempting to implement the full-scale robotic palletization solution. Providing the robotic palletization scale model may reduce overhead burden or expense or may provide a solution before a full-scale location is available. Providing the robotic palletization scale model may also assist with training and education regarding the robotic palletization before implementing the corresponding full-scale palletization system.

Various aspects of the apparatus 100 are now described in further detail. In one embodiment, the miniaturized palletization surface 102 may include the horizontal surface 104. The horizontal surface 104 may include a substantially flat horizontal surface. The horizontal surface 104 may include plastic, metal, wood, or some other rigid material. The horizontal surface 104 may be operable to support various components of the apparatus 100. The various components of the apparatus 100 may be disposed on the horizontal surface 104. In some embodiments, the components may be disposed on the horizontal surface 104 using welding, fasteners (e.g., screws, bolts, nails), adhesive, pegs, or other hardware that may dispose the components on the horizontal surface 104. In one embodiment, at least some of the various components of the apparatus 100 may be selectably disposable on the horizontal surface 104 (i.e., the components may be disposed on or removed from the horizontal surface 104).

In some embodiments, the miniaturized conveyor 106 may include a conveying surface 114. The conveying surface 114 may include an elongated surface capable of supporting and carrying the miniaturized material mass 108. The conveying surface 114 may include a ribbon of flexible material such as plastic, canvas, or some other substantially flat and flexible material.

The miniaturized conveyor 106 may include components that translate the conveying surface 114. For example, the miniaturized conveyor may include one or more axles. At least a portion the conveying surface 114 may be disposed about at least a portion of the axle. The conveying surface 114 may be operable to move in response to a rotation of the axle. Other components capable of causing the conveying surface 114 to move are also contemplated.

The miniaturized conveyor 106 may include one or more legs. The legs may support the conveying surface 114, the axles, or other components of the miniaturized conveyor 106. The legs may be disposed on the horizontal surface 104 and may fasten to the horizontal surface 104. The conveying surface 114 may be substantially planar. The conveying surface 114 may be substantially flat or may be disposed at an incline. In some embodiments, the apparatus 100 may include multiple conveyors 106. Some of the miniaturized conveyors 106 may be arranged on the horizontal surface 104 in a series such that a first miniaturized conveyor 106 carrying a load may move the load onto a second miniaturized conveyor 106.

In some embodiments, the miniaturized conveyor 106 may move its conveying surface 114 in response to receiving one or more signals. The one or more signals may be received from a computing device. The one or more signals may control the speed of the miniaturized conveyor 106 (e.g., may cause the conveying surface 114 to move faster, slower, at a constant speed, or to not move), the direction of the miniaturized conveyor 106 (e.g., may cause the conveying surface 114 to change the direction it moves a load disposed on the conveying surface 114).

In one embodiment, the miniaturized material mass 108 may include a piece of material that includes dimensions, a weight, or some other physical characteristic that is smaller than a corresponding full-sized material mass (herein referred to simply as a “material mass”). The miniaturized material mass 108 may include plastic, wood, metal, or some other material. The miniaturized material mass 108 may include a material mass printed using a three-dimensional (3D) printer. The miniaturized material mass 108 may be substantially solid, substantially hollow, or may include some material inside the outer surface of the miniaturized material mass 108, which may provide some weight for the miniaturized material mass 108.

In some embodiments, the miniaturized material mass 108 may include miniaturized dimensions. The miniaturized dimensions may include the dimensions of the corresponding material mass that have been reduced by a predetermined miniaturization factor. For example, the material mass may include a corrugated box with the dimensions 22 inches by 16 inches by 15 inches (approx. 55.9 cm by 40.6 cm by 38.1 cm). The predetermined miniaturization factor may include 5 (i.e., the size of the miniaturized material mass 108 is 5 times smaller than the corresponding material mass). Thus, the miniaturized dimensions of the miniaturized material mass 108 is 4.4 inches by 3.2 inches by 3 inches (approx. 11.2 cm by 8.1 cm by 7.6 cm). The predetermined miniaturization factor may include 2 (i.e., the miniaturized material mass 108 is half the size of the material mass), 3 (i.e., the miniaturized material mass 108 is one-third the size of the material mass), 4-10, or some other number. The predetermined miniaturization factor may include a whole number or a decimal number.

In one embodiment, the miniaturized pallet 110 may include a surface that can be moved about the horizontal surface 104 or removed from the horizontal surface 104. The miniaturized pallet 110 may include a pallet constructed of wood that is constructed at a reduced size. The miniaturized pallet 110 being disposed on the horizontal surface 104 may include the pallet being disposed on a track 116. The miniaturized pallet 110 may be disposed on a track 116 that may be disposed on the horizontal surface 104. The track 116 may be operable to move the miniaturized pallet 110 about the horizontal surface 104. The track 116 or certain components thereof may receive one or more signals and move in response to those signals.

In one embodiment, the miniaturized articulated robot 112 may include an arm section 118. The arm section 118 may include one or more arms connected via joints. The arms and joints may allow the articulated robot 112 to articulate and reach various components disposed about the apparatus 100. The miniaturized articulated robot 112 may include an end effector 120. The end effector 120 may be disposed on an end of the arm section 118. The end effector 120 may be operable to grasp the miniaturized material mass 108. In some embodiments, the end effector 120 may include a claw, a magnet, a vacuum, a fork, a clamp, or some other hardware capable of selectably grasping and holding the miniaturized material mass 108. The magnet may include an electromagnet or some other type of magnet. The vacuum may include a suction cup that may suction the miniaturized material mass 108 to the miniaturized articulated robot 112. The claw may dispose pincers around at least a portion of the first miniaturized material mass 108 such that the pincers hold the miniaturized material mass 108 while the miniaturized articulated robot 112 moves.

In one embodiment, the miniaturized articulated robot 112 may be operable to grasp, via the end effector 120, the miniaturized material mass 108. The miniaturized articulated robot 112 may be operable to translate the miniaturized material mass 108 in a horizontal plane, vertical plane, or a depth plane. In other words, the miniaturized articulated robot 112 may be operable to carry the miniaturized material mass 108 to various locations within the reach of the miniaturized articulated robot 112.

In one embodiment, the operation of the miniaturized articulated robot 112 may be operable to grasp a miniaturized product and pack the miniaturized product into a miniaturized container. This grasping-and-packing operation may include similar functionality to the grasping-and-palletization disclosed above. The miniaturized product may correspond to a full-sized, real-world product, and the miniaturized container may correspond to a full-sized, real world container. The container may include a box, a carton, a barrel, or some other type of container. The miniaturized container may be selectably disposed on the miniaturized pallet 110 or on some other location on the palletization surface 102.

In some embodiments, the miniaturized articulated robot 112 may receive one or more signals that may cause the miniaturized articulated robot 112 to perform one or more functions or operations. The one or more functions or operations may include rotating a portion of the miniaturized articulated robot 112 (such as the base, an arm of the arm section 118, or the end effector 120), extending a portion of the miniaturized articulated robot 112, operating the end effector 120, or some other function or operation. These functions or operations may assist the miniaturized articulated robot 112 in the palletization process disclosed herein. The one or more signals may be based on, or generated from, software executed by a computing device.

The software associated with the one or more signals may include palletization software. The palletization software may generate the one or more signals that control the miniaturized articulate robot 112. In some embodiments, the palletization software may generate the one or more signals based on a palletization solution. The palletization solution may include a palletization pattern. The palletization pattern may include a way to palletize material masses (and the miniaturized material masses 108). In some embodiments, the palletization solution may be generated by pallet-solving software.

Pallet-solving software may include software that determines an efficient way of moving loads from a conveyor, such as the miniaturized conveyor 106, to another location, such as the miniaturized pallet 110, (palletizing) or vice versa (de-palletizing). Pallet-solving software may use, as input, information of the load such as dimensions, weight, or other load characteristics. The software may also use, as input, information about an articulated robot, such as the miniaturized articulated robot 112. The pallet-solving software may output palletization patterns, import patterns, or the one or more signals. In some embodiments, the palletization software may include the pallet-solving software or the pallet-solving functionality of the pallet-solving software, and in other embodiments, the palletization software and the pallet-solving software may include separate pieces of software.

The one or more signals may operate on the hardware or software of the miniaturized articulated robot 112 and cause the miniaturized articulated robot 112 to move in specific motions. The one or more signals may cause the miniaturized articulated robot 112 to articulate, pivot about a base, open, close, activate, or deactivate the end effector 120, swivel or rotate the end effector 120 or a portion of the arm section 118, or perform other functionality.

In some embodiments, one or more components of the apparatus 100 may be printed using a 3D printer. For example, one or more of the palletization surface 102, the miniaturized conveyor 106, the miniaturized material mass 108, the miniaturized pallet 110, the miniaturized articulated robot 112, the track 116, or other components of the apparatus 100 may be 3D-printed.

In one or more embodiments, one or more components of the apparatus 100 may each include a scaled-down version of its corresponding real-world counterpart, and the scaled-down components may each be scaled-down by the same amount. Each scaled-down component may include a predetermined miniaturization factor, and the predetermined miniaturization factor of the scaled down components may be equal. For example, the miniaturized material mass 108 may include a predetermined miniaturization factor of 5 (i.e., the miniaturized material mass 108 may be one-fifth of the size of its real-world corresponding material mass). The miniaturized pallet 110 may also include a predetermined miniaturization factor of 5, which may result in the miniaturized material mass 108 and the miniaturized pallet 110 being reduced at the same scale.

In one embodiment, the positioning of one or more components of the apparatus 100 may include a scaled-down version of the positioning of the corresponding real-world components. For example, if the predetermined miniaturization factor is 5 and the miniaturized pallet 110 is positioned 6 inches (approx. 15.24 cm) away from the miniaturized conveyor 106, then the corresponding, real-world, scaled-up pallet and conveyor may be 30 inches (approx. 76.2 cm) apart. Thus, the apparatus 100 and the various components thereof may include a scaled-down version of a full-sized, real-world palletization system, including the scaled-down sizes and positions of the components.

In one embodiment, the real-world, scaled-up palletization system may include palletization system physical properties. The palletization system physical properties may include at least two types of properties: product properties and environment properties. The product properties may include the physical properties of the material mass and the physical properties of the pallet. The material mass physical properties may include the dimensions, sizes, weight, or other physical properties of the material mass. The pallet physical properties may include the dimensions, weight, sizes, or other physical properties of the pallet. The environment properties may include the physical properties of the palletization system that are not included in the product properties. The environment properties may include a ceiling height, a wall position, a position of a conveyor, a height of the conveyor above the palletization surface, a position of an articulated robot, an articulated robot's base's height above the palletization surface, a position of the articulated robot from the pallet, or a reach of the articulated robot. The environment properties may include dimensions, sizes, positions, or other information about a conveyor, sensor, or other equipment that may be present in a palletization area.

In some embodiments, the system 100 may include corresponding miniaturized palletization system physical properties. In one or more embodiments, the product properties may be reduced by a first predetermined miniaturization factor, and the environment properties may be reduced by a second predetermined miniaturization factor in order to provide the system 100 and obtain the miniaturized palletization system physical properties. For example, the first predetermined miniaturization factor may include 5 (i.e., the miniaturized material mass 108 and the miniaturized pallet 110 may be 5 times smaller than the full-scale, real-world material mass and pallet), and the second predetermined miniaturized factor may include 4 (i.e., the miniaturized articulated robot 112 and the distance from the miniaturized articulated robot 112 to the miniaturized pallet 110 may be 4 times smaller than the full-scale, real-world counterparts).

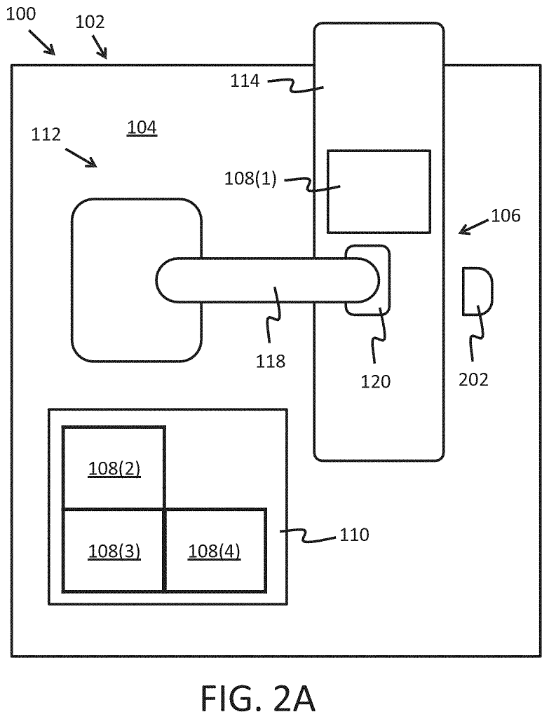

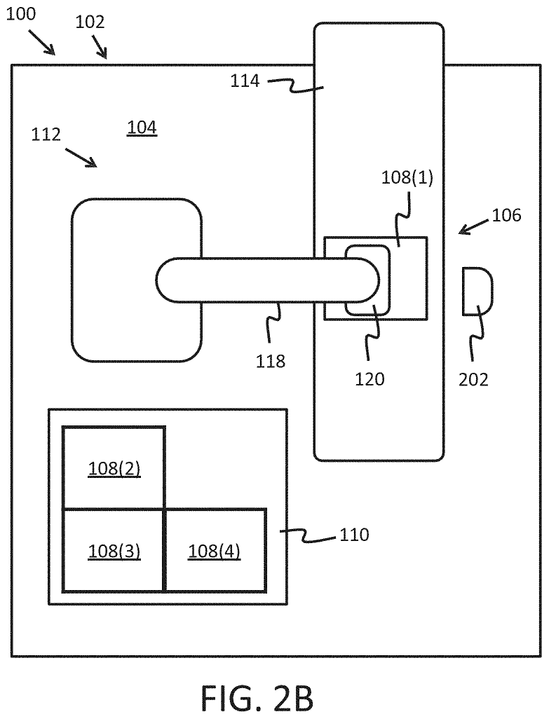

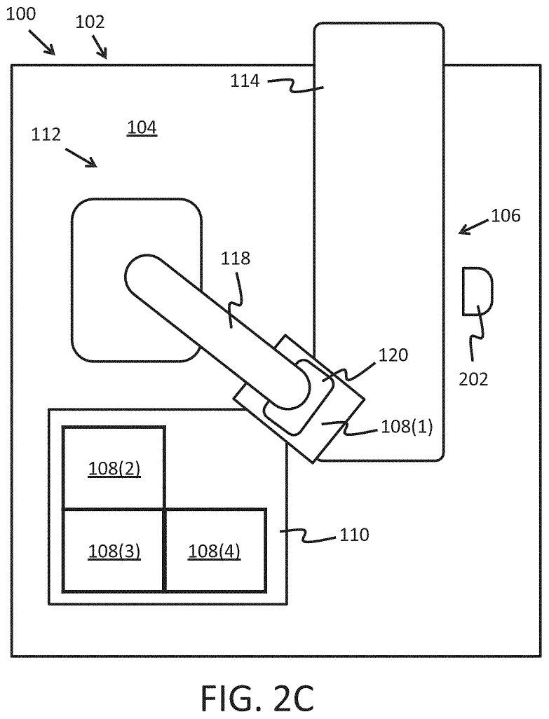

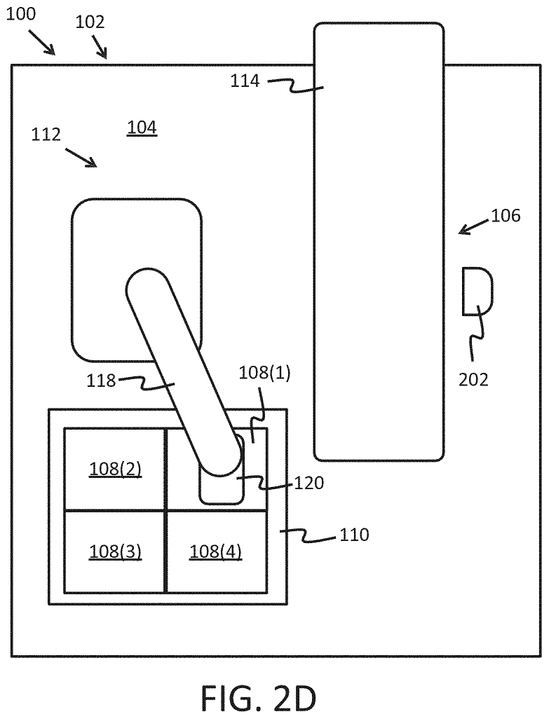

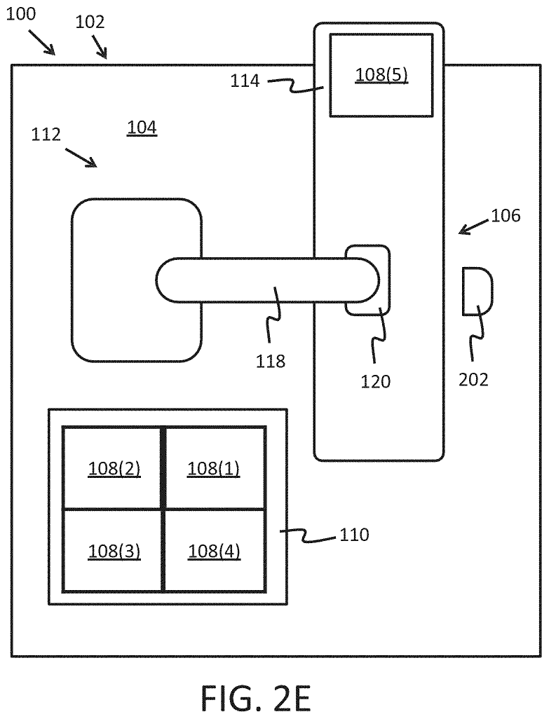

FIGS. 2A-2E depict several embodiments of the apparatus 100. Similar to FIG. 1, the apparatus 100 depicted in FIGS. 2A-2E may include the miniaturized palletization surface 102 with the horizontal surface 104; a miniaturized conveyor 106 with the conveying surface 114; the miniaturized material mass 108(1); the miniaturized pallet 110, the miniaturized articulated robot 112 with the arm section 118 and the end effector 120. The miniaturized pallet 110 may already have multiple miniaturized material masses 108(2)-(4) already disposed on it. As shown in FIGS. 2A-2E, in some embodiments, the miniaturized articulated robot 112 being operable to translate the miniaturized material mass 108(1) in a horizontal plane, a vertical plane, and a depth plane may include elevating the miniaturized material mass 108(1), disposing the miniaturized material mass 108(1) over the miniaturized pallet 110 or another miniaturized material mass 108(2), and lowering the miniaturized material mass 108(1).

As depicted in FIG. 2A, the miniaturized material mass 108(1) may be disposed on the miniaturized conveyor 106. This may include the miniaturized material mass 108(1) being disposed on the conveying surface 114 of the miniaturized conveyor 106. The miniaturized articulated robot 112 may be disposed near the miniaturized conveyor 106 and the miniaturized pallet 110 such that both are within the reach of the arm section 118 and end effector 120. As depicted in FIG. 2B, the conveying surface 114 may move the miniaturized material mass 108(1) forward (i.e., toward an area reachable by the articulated robot 112), which in FIG. 2B is downward. The miniaturized articulated robot 112 may be operable to grasp the miniaturized material mass 108(1).

As depicted in FIGS. 2C and 2D, the miniaturized articulated robot 112 may be operable to elevate the miniaturized material mass 108(1) and move the miniaturized material mass 108(1) from over the miniaturized conveyor 106 and dispose it over the miniaturized pallet 110. As depicted in FIG. 2D, the miniaturized articulated robot 112 may lower the miniaturized material mass 108(1). In some embodiments, lowering the miniaturized material mass 108(1) 108 may include lowering it directly onto the miniaturized pallet 110 (as is depicted in FIG. 2D) or, in other embodiments, onto a second miniaturized material mass 108(2), 108(3), or 108(4) that is already disposed on the miniaturized pallet 110. As depicted in FIG. 2E, the miniaturized articulated robot 112 may move its arm section 118 back to the position depicted in FIG. 2A so that the miniaturized articulated robot 112 is ready to grasp the next miniaturized material mass 108(5). This process of the miniaturized articulating robot 112 moving the miniaturized material mass 108 from the miniaturized conveyor 106 to the miniaturized pallet 110 may be called “palletization.”

In one embodiment, a sensor 202 may be operable to detect the position, speed, or other movement information of the miniaturized material mass 108 while it is on the conveying surface 114. The computing device in data communication with the miniaturized articulated robot arm 112 may receive data from the sensor and predict the position of the miniaturized material mass 108 in the future such that the computing device can generate one or more signals that cause the miniaturized articulate robot 112 to reach the future position of the miniaturized material mass 108 and grasp it with the end effector 120. The sensor 202 may include an optical sensor, a ultrasonic sensor, a camera, or other types of sensors capable of detecting information about the apparatus 100. The sensor 202 may be disposed above the apparatus 100, on a component of the apparatus 100, or in some other location.

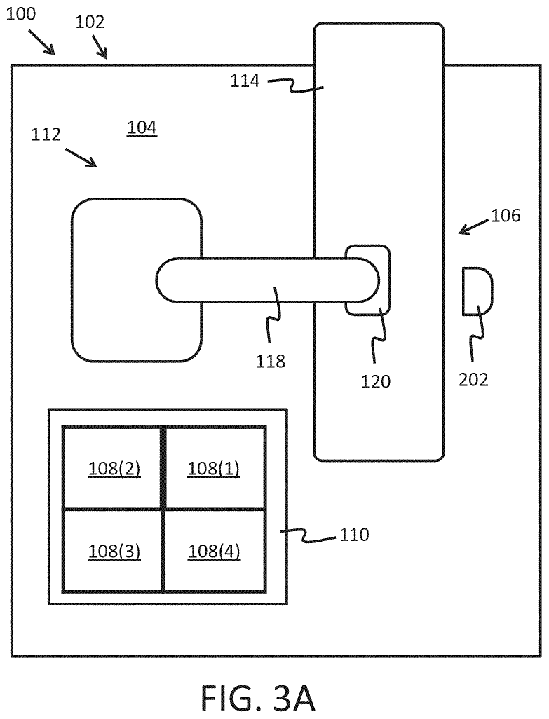

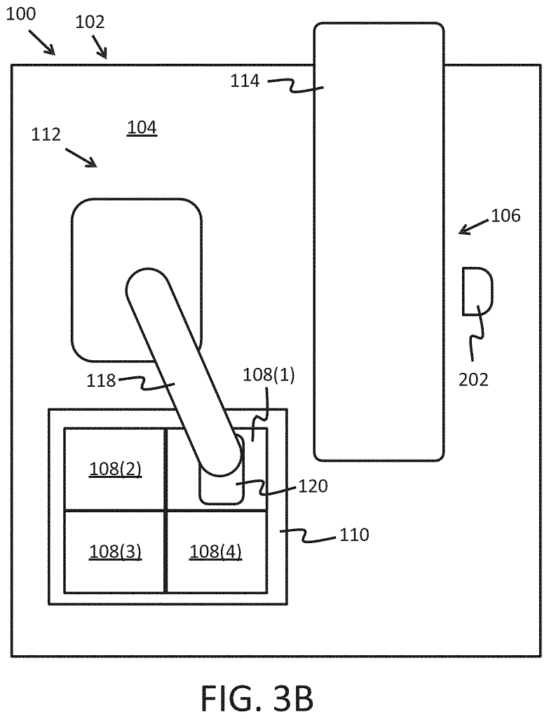

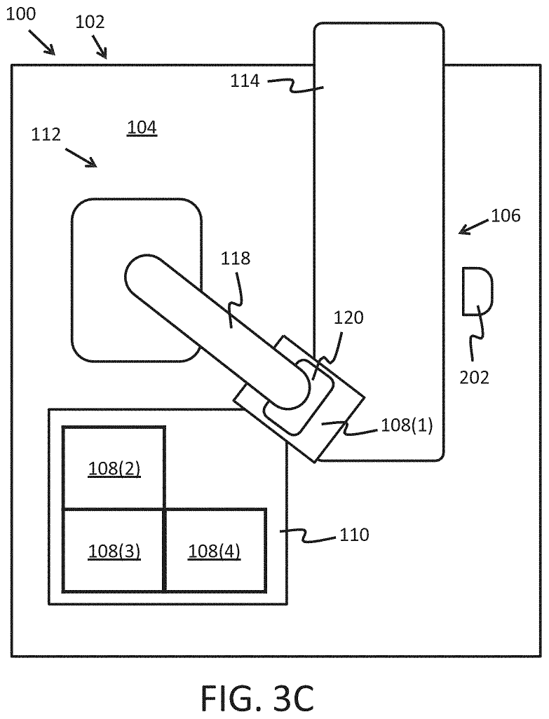

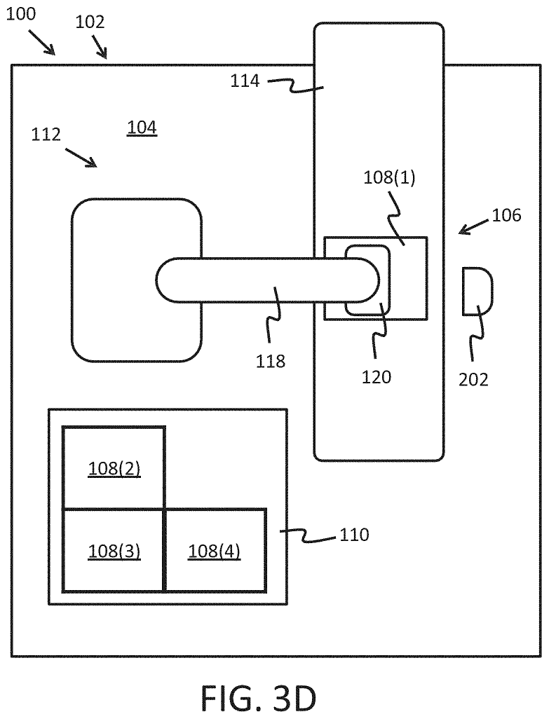

FIGS. 3A-3D depict another embodiment of the apparatus 100. As depicted in FIGS. 3A-3D, in some embodiments, the miniaturized articulated robot 112 being operable to translate the miniaturized material mass 108(1) in the horizontal, vertical, and depth planes may include elevating the miniaturized material mass 108(1), disposing the miniaturized material mass 108(1) over the conveying surface 114 of the miniaturized conveyor 106, and lowering the miniaturized material mass 108(1) onto the conveying surface 114.

In some embodiments, the conveying surface 114 may move away from an area reachable by the articulated robot 112, which in FIGS. 3A-3D is upward. As depicted in FIG. 3A, the miniaturized material mass 108(1) may be disposed on the miniaturized pallet 110. As depicted in FIG. 3B, the miniaturized articulated robot 112 may be operable to grasp the miniaturized material mass 108(1) and elevate the miniaturized material mass 108(1). As depicted in FIGS. 3C-3D the miniaturized articulated robot 112 may be operable to dispose the miniaturized material mass 108(1) over the conveying surface 114 of the miniaturized conveyor 106 and lower the miniaturized material mass 108(1) onto the conveying surface 114. This process may be called “de-palletization.” Similar to the palletization process described above, the apparatus 100 may use the sensor 202 to determine the position of the miniaturized material 108(1), whether the conveying surface 114 has room for the miniaturized material mass 108(1), or to determine other information useful for controlling the miniaturized articulated robot 112.

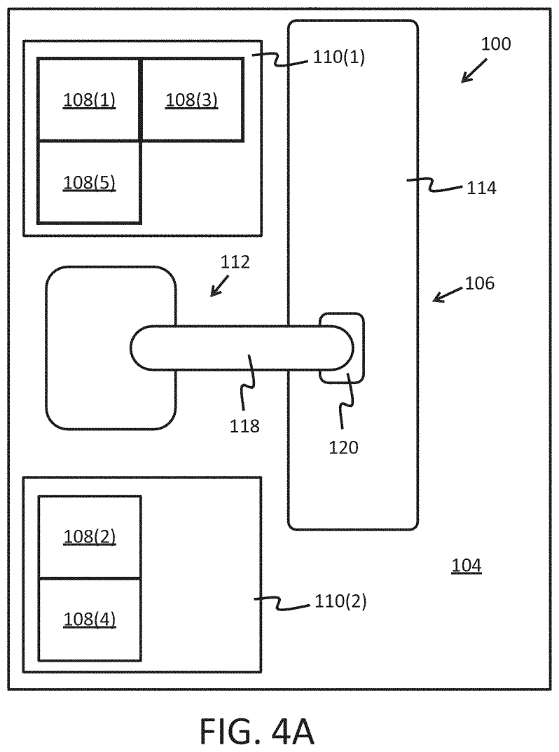

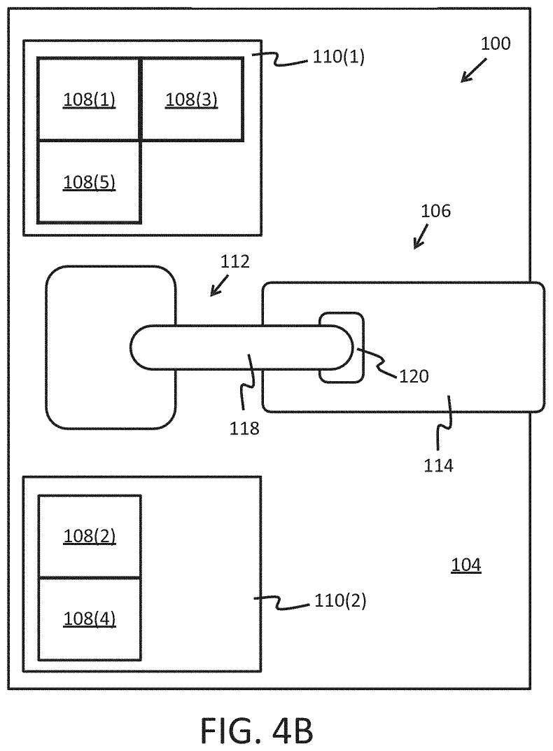

In one embodiment, the configuration of the single miniature conveyor 106, the single miniature pallet 110, and the single miniature articulated robot 112 depicted in FIGS. 2A-2E and FIGS. 3A-3D may be called a “one-in one-out” configuration. This means that the miniaturized articulated robot 112 has a single load infeed (i.e., the miniaturized conveyor 106) and a single load output (i.e., the miniaturized pallet). Other configurations as also available. For example, FIG. 4A depicts one embodiment of a one-in two-out configuration. As can be seen, the miniaturized articulated robot 112 may unload miniaturized material masses 108(1)-(n) from the miniaturized conveyor 106 onto two different miniaturized pallets 110(1)-(2). The miniaturized articulated robot 112 may alternately palletize the two miniaturized pallets 110(1)-(2) (e.g., the miniaturized articulated robot 112 may palletize the first miniaturized material mass 108(1) to the first miniaturized pallet 110(1), the second miniaturized material mass 108(2) to the second miniaturized pallet 110(2), the third miniaturized material mass 108(3) to the first miniaturized pallet 110(1), and so on), or may continue to palletize a single miniaturized pallet 110(1) until full and then may palletize a different miniaturized pallet 110(2). The miniaturized articulated robot 112 may be disposed between the two miniaturized pallets 110(1)-(2). The miniaturized conveyor 106 may be disposed such that it runs parallel to the two miniaturized pallets 110(1) (as depicted in FIG. 4A), or the miniaturized conveyor 106 may be disposed such that the conveying surface 114 approaches the miniaturized articulated robot 112 in a more direct manner (as is depicted in FIG. 4B).

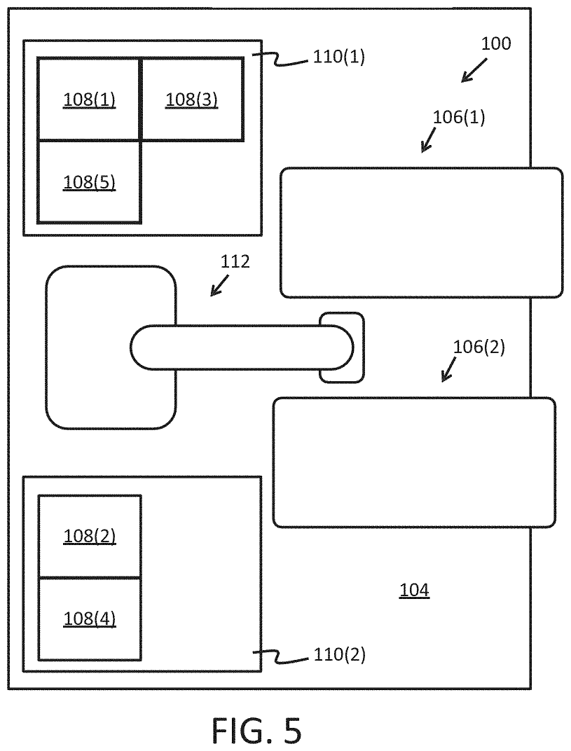

FIG. 5 depicts one embodiment of a two-in two-out configuration. As can be seen, the miniaturized articulated robot 112 may unload two miniaturized conveyors 106(1)-(2) onto two different miniaturized pallets 110(1)-(2). Other configurations are also possible such as two-in one-out, three-in two-out, three-in three-out, or n-in m-out where n is the number of infeeds and m is the number of outputs.

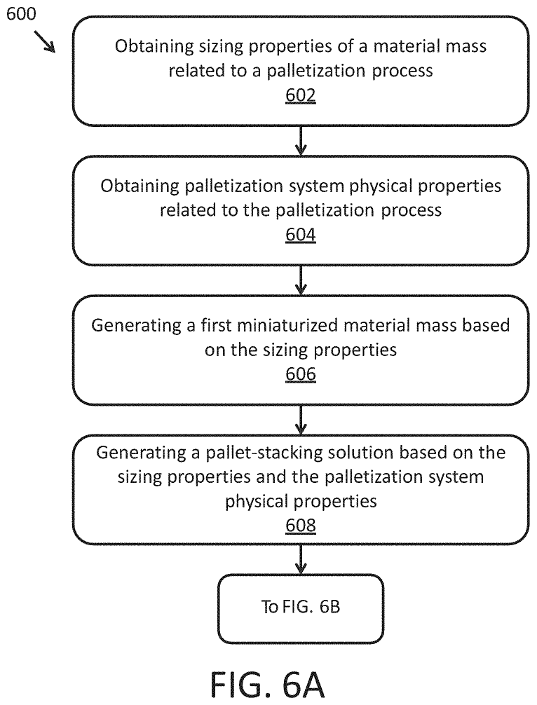

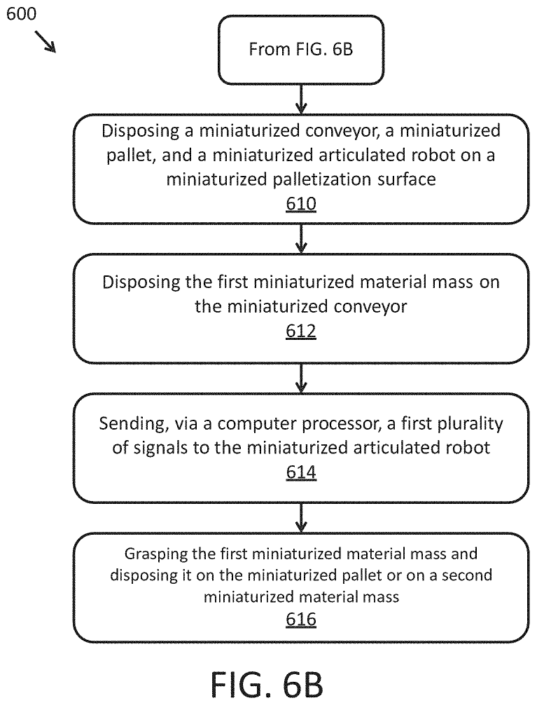

FIGS. 6A-6B depict one embodiment of a method 600. The method 600 may include a method for palletization miniaturization and demonstration. The method 600 may include obtaining sizing properties of a material mass related to a palletization process (step 602). The method 600 may include obtaining palletization system physical properties related to the palletization process (step 604). The method 600 may include generating a first miniaturized material mass based on the sizing properties (step 606). The method 600 may include generating a pallet-stacking solution based on the sizing properties and the palletization system physical properties (step 608). The method 600 may include disposing, based on the palletization system physical properties, a miniaturized conveyor, a miniaturized pallet, and a miniaturized articulated robot on a miniaturized palletization surface (step 610). The method 600 may include disposing the first miniaturized material mass on the miniaturized conveyor (step 612). The method 600 may include sending, via a computing device, a first plurality of signals to the miniaturized articulated robot, wherein the first plurality of signals are based on the pallet-stacking solution (step 614). The method 600 may include in response to receiving the first plurality of signals at the miniaturized articulated robot, grasping, via an end effector of the miniaturized articulated robot, the first miniaturized material mass and disposing, via the miniaturized articulated robot, the first miniaturized material mass on the miniaturized pallet or on a second miniaturized material mass (616).

In one embodiment, obtaining sizing properties of the material mass related to the palletization process (step 602) may include receiving the sizing properties at a computing device. The computing device may receive the sizing properties from a user interface, a file, a database, or some other data source. The computing device may receive the sizing properties from the computing device or from a remote computing device in data communication with the computing device.

In some embodiments, the sizing properties may include dimensions of the material mass. For example, the material mass may include a corrugated box with the dimensions 22 inches by 16 inches by 15 inches (approx. 55.9 cm by 40.6 cm by 38.1 cm), and the sizing properties may include 22 inches by 16 inches by 15 inches. The dimensions may include one or more heights, widths, lengths, or other dimensional data. The dimensions may include a variety of shapes such as rectangular prisms, ellipsoid, cylinders, or other shapes. The dimensions may describe an irregularly shaped material mass.

In one embodiment, obtaining palletization system physical properties related to the palletization process (step 604) may include similar actions or steps as step 602. This may include receiving the palletization system physical properties at a computing device and other functionality described above in relation to step 602. In some embodiments, the palletization system physical properties may include a ceiling height, a wall position, a position of a conveyor, or a position of an articulated robot. The palletization system physical properties may include a reach of the articulated robot. The palletization system physical properties may include dimensions, sizes, positions, or other information about a pallet, conveyor, sensor, or other equipment that may be present in a palletization area.

In one or more embodiments, generating the first miniaturized material mass based on the sizing properties (step 606) may include generating the miniaturized material mass 108. Generating the first miniaturized material mass 108(1) based on the sizing properties may include receiving the dimensions of the material mass. The computing device may receive the dimensions at described above in relation to step 602. Generating the first miniaturized material mass 108(1) may include obtaining miniaturized dimensions. Obtaining the miniaturized dimensions may include reducing the dimensions of the material mass by a predetermined miniaturization factor. The computing device may receive the predetermined miniaturization factor similar to obtaining the sizing properties (via user input, a file, a database, etc.).

Generating the first miniaturized material mass 108(1) may include constructing the first miniaturized material mass, and the first miniaturized material mass 108(1) may include the miniaturized dimensions. In one embodiment, constructing the first miniaturized material mass 108(1) may include printing the first miniaturized material mass 108(1) with a three-dimensional printer. For example, the material mass may include a corrugated box with the dimensions 22 inches by 16 inches by 15 inches (approx. 55.9 cm by 40.6 cm by 38.1 cm). The predetermined miniaturization factor may include 5 (i.e., the size of the first miniaturized material mass 108(1) is 5 times smaller than the material mass). Constructing the first miniaturized material mass 108(1) may include a three-dimensional printer printing the first miniaturized material mass 108(1) to be sized 4.4 inches by 3.2 inches by 3 inches (approx. 11.2 cm by 8.1 cm by 7.6 cm).

In one embodiment, generating the pallet-stacking solution based on the sizing properties and the palletization system physical properties (step 608) may include generating a pattern for stacking the one or more miniaturized material masses 108(1)-(n) on the miniaturized pallet 110. For example, pallet-solving software on the computing device may import or otherwise receive the data corresponding to the sizing properties and the palletization system physical properties and generate a pallet-solving solution. The pallet-solving solution may include a file or other storable data. The pallet-solving solution may include a software program or some other form of computer-readable instructions.

In some embodiments, disposing, based on the palletization system physical properties, the miniaturized conveyor, the miniaturized pallet, and the miniaturized articulated robot on a miniaturized palletization surface (step 610) may include disposing the miniaturized conveyor 106, the miniaturized pallet 110, or the miniaturized articulated robot 112. Disposing the miniaturized conveyor 106, the miniaturized pallet 110, or the miniaturized articulated robot 112 may include disposing these components to comply with the palletization system physical properties. For example, the miniaturized conveyor 106 may be positioned such that it does not pass through a wall. The miniaturized articulated robot 112 may be selected from among multiple miniaturized articulated robots 112, such that the miniaturized articulated robot 112 does not exceed a ceiling height. The miniaturized articulated robot 112 may be disposed within reach of one or more miniaturized conveyors 106.

In some embodiments, disposing the first miniaturized material mass on the miniaturized conveyor (step 612) may include disposing the first miniaturized material mass 108(1) on the miniaturized conveyor 106. The miniaturized conveyor 106 may include the conveying surface 114, which may move the first miniaturized material mass 108(1) along the miniaturized conveyor 106 and within reach of the miniaturized articulated robot 112.

In one embodiment, sending, via the computing device, a first plurality of signals to the miniaturized articulated robot, wherein the first plurality of signals are based on the pallet-stacking solution (step 614) may include the computing device sending one or more signals that the miniaturized articulated robot 112 can receive, interpret, and which cause the miniaturized articulated robot 112 to perform various functions. In some embodiments, the one or more signals may include software that is stored on circuitry of the miniaturized articulated robot 112 and which the miniaturized articulated robot 112 uses to perform various functions. In some embodiments, the one or more signals may include a file that the miniaturized articulated robot 112 can store and read from in order to execute various functions. In another embodiment, the one or more signals may include computer-readable instructions received by the miniaturized articulated robot 112. In some embodiments where the instructions, files, or other data are stored on the miniaturized articulated robot 112, the miniaturized articulated robot 112 may not need to be connected to a computing device in order to perform palletization or de-palletization functions. This may allow the apparatus 100 to be more mobile.

In one or more embodiments, grasping, via the end effector of the miniaturized articulated robot, the first miniaturized material mass and disposing, via the miniaturized articulated robot, the first miniaturized material mass on the miniaturized pallet or on a second miniaturized material mass (616) may include the end effector 120 grasping the first miniaturized material mass 108(1) while on the miniaturized conveyor 106, moving the first miniaturized material mass 108(1) from the miniaturized conveyor 106 to over the miniaturized pallet 106, and lowering the first miniaturized material mass 108(1) onto the miniaturized pallet or onto a the second miniaturized material mass 108(2) already disposed on the miniaturized pallet 110. This may be similar to the palletization process described above in relation to FIGS. 2A-2E.

In one embodiment, the method 600 may further include disposing the first miniaturized material mass 108(1) on the miniaturized pallet 110 or the second miniaturized material mass 108(2). The method 600 may further include sending, via the computing device, a second plurality of signals to the miniaturized articulated robot 112. The second plurality of signals may be also based on a pallet-stacking solution. The method 600 may include, in response to receiving the second plurality of signals at the miniaturized articulated robot 112, grasping, via the end effector 120 of the miniaturized articulated robot 112, the first miniaturized material mass 108(1) and disposing, via the miniaturized articulated robot 112, the first miniaturized material mass 108(1) on the miniaturized conveyor 106. This may be similar to the de-palletization process described above in relation to FIGS. 3A-3D.

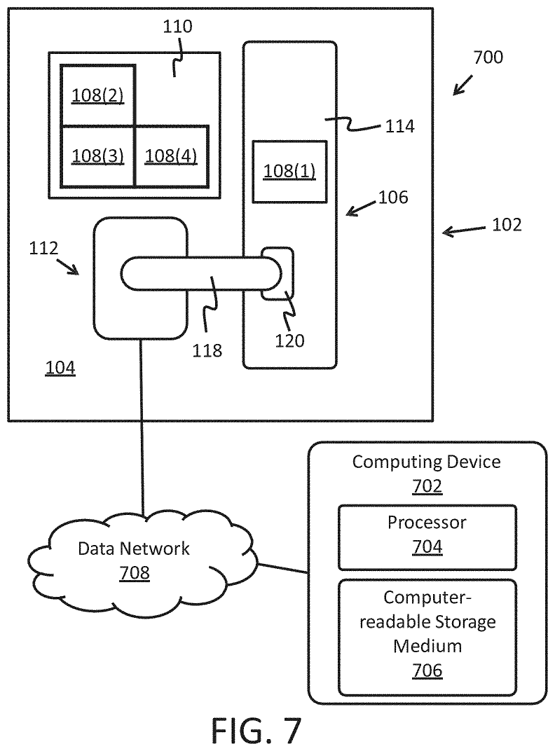

FIG. 7 depicts one embodiment of a system 700. The system 700 may include a system for palletization miniaturization and demonstration. The system 700 may include the apparatus 100, as depicted in FIG. 7. The system 700 may include a computing device 702. The computing device 702 may include an application server, a database server, a desktop computer, a laptop computer, a tablet computer, or some other computing device.

The computing device 702 may include at least one processor 704. The processor 704 may include a central processing unit (CPU), graphical processing unit (GPU), or some other type of processing unit. The processor 704 may include one or more cores. The processor 704 may be operable to process data, execute computer-readable instructions, or perform other computing operations.

In some embodiments, the computing device 702 may include a computer-readable storage medium 706. The computer-readable storage medium 706 may include one or more computer-readable instructions. The computer-readable instructions may be executable by the processor 704. When the computer-readable instructions are executed by the processor 704, the processor 704 may be operable to send one or more signals to the miniaturized articulated robot 112. The miniaturized articulated robot 112, in response to receiving the one or more signals, may be operable to grasp, via the end effector 120, the miniaturized material mass 108 and translate the miniaturized material mass 108 in a horizontal plane, a vertical plane, and a depth plane. In some embodiments, the one or more computer-readable instructions may include pallet-solving software.

The computing device 702 may be in data communication with the articulated robot 112 via a data network 708 such as a local area network (LAN), wide area network (WAN), the Internet, or other data network components. The data network may include wired or wireless components. The miniaturized articulated robot 112 may be in data communication with the data network 708. In some embodiments, the data network 708 may include one or more electrical cables that may send electrical signals that may not necessarily include digital data.

An example of the method 600 using various components of the system 700 is now described. At step 602 of the method 600, the computing device 702 may obtain sizing properties of a material mass related to a palletization process. The computing device 702 may obtain the sizing properties via the data network 708 in the form of a file. Pallet-solving software may import the file, read the file, and process the data contained within the file. The sizing properties may include the dimensions 22 inches by 16 inches by 15 inches (approx. 55.9 cm by 40.6 cm by 38.1 cm).

At step 604, the computing device 702 may obtain the palletization system physical properties related to the palletization process. The computing device may obtain the palletization system physical properties from a database in data communication with the computing device 702 over the data network 708. The palletization system physical properties may include the ceiling height, the positions of multiple walls, the position of a conveyor, the position of the articulated robot, the reach of the articulated robot, the position of the pallet, and the dimensions of the pallet. The pallet-solving software may import at least some of this data.

At step 606, the computing device 702 may send a file based on the sizing properties to a three-dimensional printer. The three-dimensional printer may generate a first miniaturized material mass 108 based on the sizing properties contained within the file. The three-dimensional printer may generate several miniaturized material masses 108(1)-(n). Some of the miniaturized material masses 108(1)-(n) may include different dimensions.

At step 608, the pallet-solving software of the computing device 702 may generate a pallet-stacking solution based on the sizing properties and the palletization system physical properties. The pallet-stacking solution may describe a stacking pattern that efficiently stacks the miniaturized material masses 108(1)-(n) on the miniaturized pallet 110.

At step 610, a machine, person, or other entity may dispose, based on the palletization system physical properties, the miniaturized conveyor 106, the miniaturized pallet 110, and the miniaturized articulated robot 112 on a miniaturized palletization surface 102. Some of these components may be selectably disposed on the miniaturized palletization surface 102 using fasteners. Since the components are miniaturized versions of full-scale components, it is relatively easy to move them around and dispose them on the miniaturized palletization surface 102.

At step 612, the machine, person, or other entity may dispose the first miniaturized material mass 108(1) on the miniaturized conveyor 106. This step may include disposing the first miniaturized material mass 108(1) at an end of the miniaturized conveyor 106 such that the conveying surface 114 may move the first miniaturized material mass 108(1) toward the miniaturized articulated robot 112. This step may also include disposing multiple miniaturized material masses 108(1)-(n) on the miniaturized conveyor 106. The multiple miniaturized material masses 108(1)-(n) may be disposed in a series on the miniaturized conveyor 106.

At step 614, the computing device 702 may send one or more signals to the miniaturized articulated robot 112. The one or more signals may be based on the pallet-stacking solution. The one or more signals may include software that is stored on circuitry of the miniaturized articulated robot 112 and which the miniaturized articulated robot 112 uses to perform various functions.

At step 616, in response to receiving the first plurality of signals at the miniaturized articulated robot 112, the miniaturized articulated robot 112 may use its end effector 120 to grasp the first miniaturized material mass 108(1) that is disposed on the conveying surface 114 of the miniaturized conveyor 106. The miniaturized articulated robot 112 may elevate the first miniaturized material mass 108(1), pivot to dispose the first miniaturized material mass 108(1) over the miniaturized pallet 110, lower the first miniaturized material mass 108(1) onto the miniaturized pallet 110, and release the grasp of the end effector 120. The system 700 may repeat step 616 on multiple miniaturized material masses 108(1)-(n) in order to demonstrate a palletization process. The system 700 may also function as disclosed herein to demonstrate a de-palletization process.

As can be seen from the present disclosure, the systems and methods disclosed herein may provide a demonstration of a palletization or de-palletization process at a reduced scale. The demonstration at the reduced scale may demonstrate the success of the palletization/de-palletization process without having to implement a full-scale solution. The miniaturized material mass 108 can be quickly constructed (e.g., printed with a three-dimensional printer), which allows the scaled-down demonstration to be quickly and accurately constructed. In some embodiments, the apparatus 100 or system 700 may be mobile such that the apparatus 100 or system 700 can be transported to a potential customer seeking a palletization solution, or the potential customer can travel to the apparatus 100 or system 700 to view the demonstration. In other embodiments, the apparatus 100 or system 700 can be livestreamed while in action to the potential customer via the Internet, or the apparatus 100 or system 700 can be video recorded and the video recording can be sent to the potential customer. In some embodiments, the miniaturized palletization/de-palletization solution may assist with training or educational purposes. The miniaturized systems disclosed herein may be demonstrated to students in a classroom or other convenient location and without the students needing to travel to a location where a full-scale palletization solution is implemented. The miniaturized systems may be demonstrated to trainees or other workers who may interact with the full-scale solution at a later time or who may interact with it remotely without having to travel to a location where the full-scale solution is implemented.

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and may be covered by the claims.

Furthermore, the described features, structures, or characteristics of the disclosure may be combined in any suitable manner in one or more embodiments. In the description contained herein, numerous specific details are provided, such as examples of programming, software, user selections, hardware, hardware circuits, hardware chips, or the like, to provide understanding of embodiments of the disclosure. One skilled in the relevant art will recognize, however, that the disclosure may be practiced without one or more of the specific details, or with other methods, components, materials, and so forth. In other instances, well-known structures, materials, or operations may not be shown or described in detail to avoid obscuring aspects of the disclosure.

These features and advantages of the embodiments will become more fully apparent from the description and appended claims, or may be learned by the practice of embodiments as set forth herein. As will be appreciated by one skilled in the art, aspects of the present disclosure may be embodied as an apparatus, system, method, computer program product, or the like. Accordingly, aspects of the present disclosure, such as one or more steps of the method 600 or some of the functionality of the miniaturized articulated robot 112 or the processor 702, may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer-readable medium(s) having program code embodied thereon.

In some embodiments, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer-readable medium(s).

In some embodiments, a module may include a smart contract hosted on a blockchain. The functionality of the smart contract may be executed by a node (or peer) of the blockchain network. One or more inputs to the smart contract may be read or detected from one or more transactions stored on or referenced by the blockchain. The smart contract may output data based on the execution of the smart contract as one or more transactions to the blockchain. A smart contract may implement one or more methods or algorithms described herein.

The computer program product may include a computer-readable storage medium (or media) having computer-readable program instructions thereon for causing a processor to carry out aspects of the present disclosure. The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium may include a portable computer diskette, a hard disk, a random access memory (“RAM”), a read-only memory (“ROM”), an erasable programmable read-only memory (“EPROM” or Flash memory), a static random access memory (“SRAM”), a hard disk drive (“HDD”), a solid state drive, a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations or block diagrams of methods, apparatuses, systems, algorithms, or computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flow chart diagrams included herein are generally set forth as logical flow chart diagrams. As such, the depicted order and labeled steps are indicative of one embodiment of the presented method. Other steps and methods may be conceived that may be equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Thus, although there have been described particular embodiments of the present invention of new and useful systems and methods for palletization miniaturization and demonstration, it is not intended that such references be construed as limitations upon the scope of this invention.

1. An apparatus, comprising:
a first palletization surface, comprising
a first horizontal surface, and
a first conveyor disposed on the first horizontal surface, the first conveyor comprising a first conveying surface;
a first material mass;
a first pallet disposed on the first horizontal surface;
a first articulated robot disposed on the first horizontal surface, comprising
a first arm section, and
a first end effector disposed on an end of the first arm section;
a miniaturized palletization surface, comprising
a miniature horizontal surface, and
a miniaturized conveyor disposed on the miniature horizontal surface, the miniaturized conveyor comprising a miniature conveying surface;
a miniaturized material mass;
a miniaturized pallet disposed on the miniature horizontal surface;
a miniaturized articulated robot disposed on the miniature horizontal surface, comprising
a miniature arm section, and
a miniature end effector disposed on an end of the miniature arm section,
wherein
the miniaturized conveyor, miniaturized material mass, miniaturized pallet, and miniaturized articulated robot are miniature versions of the corresponding first conveyor, first material mass, first pallet, and first articulated robot that have each been scaled down by an identical predetermined miniaturization factor;
the miniaturized pallet is disposed within a reach of the arm section of the miniaturized articulated robot, and
the miniaturized articulated robot is operable to
grasp, via the miniature end effector, the miniaturized material mass, and
translate the miniaturized material mass along an X, Y, and Z axes.

2. The apparatus of claim 1, wherein the miniaturized material mass comprises a three-dimensional printer-printed mass.

3. The apparatus of claim 2, wherein the miniaturized material mass comprises a rectangular prism shape.

4. The apparatus of claim 1, wherein:
the miniaturized material mass is disposed on the miniaturized conveyor; and
the miniaturized articulated robot being operable to translate the miniaturized material mass along the X, Y, and Z axes comprises the miniaturized articulated robot being operable to
elevate the miniaturized material mass,
dispose the miniaturized material mass over the miniaturized pallet, and
lower the miniaturized material mass.

5. The apparatus of claim 1, wherein:
the miniaturized material mass is disposed on the miniaturized pallet; and
the miniaturized articulated robot being operable to translate the miniaturized material mass along the X, Y, and Z axes comprises the miniaturized articulated robot being operable to
elevate the miniaturized material mass,
dispose the miniaturized material mass over the miniature conveying surface of the miniaturized conveyor, and
lower the miniaturized material mass onto the miniature conveying surface.

6. The apparatus of claim 1, wherein the miniature end effector of the miniaturized articulated robot comprises at least one of:
a vacuum;
a claw; or
a magnet.

7. A system, comprising:
A first palletization surface, comprising
a first horizontal surface, and
a first conveyor disposed on the first horizontal surface, the first conveyor comprising a first conveying surface;
a first material mass;
a first pallet disposed on the first horizontal surface;
a first articulated robot disposed on the first horizontal surface, comprising
a first arm section, and
a first end effector disposed on an end of the first arm section;
a miniaturized palletization demonstration apparatus, comprising
a miniaturized palletization surface, comprising
a miniature horizontal surface, and
a miniaturized conveyor disposed on the miniature horizontal surface, the miniaturized conveyor comprising a miniature conveying surface,
a miniaturized material mass,
a miniaturized pallet,
a miniaturized articulated robot disposed on the miniature horizontal surface, comprising
a miniature arm section, and
a miniature end effector disposed on an end of the arm section, a computing device, comprising
at least one processor, and
a computer-readable storage medium with a plurality of computer-readable instructions stored thereon, wherein when the plurality of computer-readable instructions are executed by the processor, the processor is operable to send a plurality of signals to the miniaturized articulated robot;
wherein the miniaturized articulated robot, in response to receiving the plurality of signals, is operable to
grasp, via the miniature end effector, the miniaturized material mass, and
translate the miniaturized material mass along an X, Y, and Z axes; and
wherein the miniaturized conveyor, miniaturized material mass, miniaturized pallet, and miniaturized articulated robot are miniature versions of the corresponding first conveyor, first material mass, first pallet, and first articulated robot that have each been scaled down by an identical predetermined miniaturization factor.

8. The system of claim 7, wherein the plurality of computer-readable instructions comprise pallet-solving software.

9. The system of claim 7, wherein the miniaturized articulated robot being operable to translate the miniaturized material mass along the X, Y, and Z axes comprises the miniaturized articulated robot being operable to
elevate the miniaturized material mass;
dispose the miniaturized material mass over the miniaturized pallet; and
lower the miniaturized material mass.

10. The system of claim 7, wherein:
the miniaturized material mass is disposed on the miniaturized pallet; and
the miniaturized articulated robot being operable to translate the miniaturized material mass along the X, Y, and Z axes comprises the miniaturized articulated robot being operable to
elevate the miniaturized material mass,
dispose the miniaturized material mass over the miniature conveying surface of the miniaturized conveyor, and
lower the miniaturized material mass onto the miniature conveying surface.

11. A method, comprising:
obtaining sizing properties of a material mass, a first conveyor, a first pallet, and a first articulated robot related to a palletization process;
obtaining palletization system physical properties related to the palletization process;
generating a first miniaturized material mass based on the sizing properties;
generating a pallet-stacking solution based on the sizing properties and the palletization system physical properties;
disposing, based on the palletization system physical properties, a miniaturized conveyor, a miniaturized pallet, and a miniaturized articulated robot on a miniaturized palletization surface, wherein the miniaturized conveyor, miniaturized pallet, and miniaturized articulated robot are miniature versions of the corresponding first conveyor, first pallet, and first articulated robot that have each been scaled down by an identical predetermined miniaturization factor;
disposing the first miniaturized material mass on the miniaturized conveyor;
sending, via a computing device, a first plurality of signals to the miniaturized articulated robot, wherein the first plurality of signals are based on the pallet-stacking solution; and
in response to receiving the first plurality of signals at the miniaturized articulated robot, grasping, via an end effector of the miniaturized articulated robot, the first miniaturized material mass and disposing, via the miniaturized articulated robot, the first miniaturized material mass on the miniaturized pallet or on a second miniaturized material mass.

12. The method of claim 11, wherein the sizing properties comprise dimensions of the material mass, first conveyor, first pallet, and first articulated robot.

13. The method of claim 12, wherein generating the first miniaturized material mass based on the sizing properties comprises:
receiving the dimensions of the material mass;
obtaining miniaturized dimensions by reducing the dimensions of the material mass by a predetermined miniaturization factor; and
constructing the first miniaturized material mass, wherein the first miniaturized material mass includes the miniaturized dimensions.

14. The method of claim 13, wherein constructing the first miniaturized material mass comprises printing the first miniaturized material mass with a three-dimensional printer.

15. The method of claim 11, wherein the palletization system physical properties comprise a ceiling height and a wall position.

16. The method of claim 11, wherein the palletization system physical properties comprise:
a position of the first conveyor; and
a position of the first articulated robot.

17. The method of claim 16, wherein the palletization system physical properties comprise a reach of the first articulated robot.

18. The method of claim 11, further comprising:
disposing the first miniaturized material mass on the miniaturized pallet or the second miniaturized material mass;
sending, via the computing device, a second plurality of signals to the miniaturized articulated robot, wherein the second plurality of signals are based on the pallet-stacking solution;
in response to receiving the second plurality of signals at the miniaturized articulated robot, grasping, via the end effector of the miniaturized articulated robot, the first miniaturized material mass and disposing, via the miniaturized articulated robot, the first miniaturized material mass on the miniaturized conveyor.

19. The method of claim 11, wherein grasping, via the end effector of the miniaturized articulated robot, the first miniaturized material mass comprises suctioning the first miniaturized material mass.

20. The method of claim 11, wherein grasping, via the end effector of the miniaturized articulated robot, the first miniaturized material mass comprises disposing a claw around at least a portion of the first miniaturized material mass.
